(19) United States
(12) Patent Application Publication
(10) Pub. No.: US 2006/0207369 A1
(43) Pub. Date: Sep. 21, 2006

(54) Adjusting device for an automotive vehicle seat with crimp connection

(75) Inventors: Burkhard Becker, Solingen, DE (US); Zalavari Kornel, Solingen, DE (US)

Correspondence Address: MCCARTER & ENGLISH LLP;CITYPLACE I, 185 ASYLUM STREET, HARTFORD, CT, 06103, US

(73) Assignee: C. Rob. Hammerstein GmgH & Co.

(21) Appl. No.: 11/326,994

(22) Filed: Jan. 5, 2006

(30) Foreign Application Priority Data
Jan. 5, 2005 (DE) DE102005000778.3
Jul. 6, 2005 (DE) DE102005031538.0

(51) Int. Cl. F16H 55/12

(52) U.S. Cl. 74/451

(57) ABSTRACT

The invention relates to an adjusting device for an automotive vehicle seat and to a method for manufacturing said adjusting device. Said adjusting device comprises a drive shaft that comprises a pinion portion and a connecting portion, a disc with a preferably central opening and a cutting ring, wherein the drive shaft extends through the central opening and is non-rotatably connected therewith, the disc, with its side turned toward the pinion portion, snugly fits against an abutment element, a groove extending about a central axis (X-X) of the drive shaft is at least in some sections formed in the outer surface of the drive shaft on the side of the disc that lies opposite the abutment element, the cutting ring employed for the crimp connection is disposed in the groove in such a manner that the disc is retained with zero clearance between the abutment element and the cutting ring in the longitudinal direction of the drive shaft.

### CROSS-REFERENCE

This application claims priority to German Application No. DE 10 2005 000 778.3, filed Jan. 5, 2005, and German Application No. DE 10 2005 031 538.0, filed Jul. 6, 2005, the contents of which are hereby expressly incorporated by reference in their entirety as part of the present disclosure

### BACKGROUND

The present invention relates to an adjusting device for an automotive vehicle seat having a drive shaft that comprises a pinion portion and a connecting portion and that extends through a preferably central opening in the disc.

Such type adjusting devices for automotive vehicle seats are generally known and are being utilized for a wide variety of applications.

Adjusting devices permit to adjust and retain an automotive vehicle seat in various positions. If the adjusting device serves for example to adjust the height of the seat part, it is responsible for the height position of the seat part with respect to a bottom surface of the vehicle. In this case, the adjusting device retains for example two adjusting arms in the angular position set by the user. If the adjusting device serves for lengthwise adjustment, only the seat part or even the entire seat may be displaced in the longitudinal direction of the vehicle. Adjusting devices are also utilized for adjusting the incline of the seat back of the automotive vehicle seat.

As a rule, adjustment is performed through a driven pinion that engages a toothed rack, a toothed quadrant or a toothed wheel. The pinion may be driven manually, that is, by hand or through an electric motor. The latter turns about 3000 revolutions per minute. Accordingly, to achieve precise and slow adjustment, strong gear reduction is needed, this being the reason why a gear is usually disposed between the electric motor and the transmission unit transmitting the rotation movement to the vehicle seat. A drive shaft protruding from the gear comprises at its free end the pinion, which engages for example a toothed rack of the vehicle seat in order to displace the latter in the longitudinal direction.

Within the gear, the drive shaft is non-rotatably connected to a disc, preferably to a toothed disc. The drive shaft thereby has a connecting portion extending through a central opening in the disc. Typically, the two components are joined together by a weldment. One disadvantage, among others, of this weldment is that it takes quite some time to make it. Further, the centricity of the drive shaft may differ from that of the toothed disc. This is due to the fact that during spot welding for example the toothed disc may not be exactly concentric with the drive shaft while the first welding is being performed. Subsequent correction is not possible. The only way to prevent this problem from arising is to keep the tolerance between the inside diameter and the outside diameter of the drive shaft so small that it is hardly possible for the disc not to be concentric. This however places considerable demands on the manufacturing of the component parts. Irrespective thereof a weldment would not only be expensive in terms of time but also in terms of cost.

### SUMMARY OF THE INVENTION

The object of the present invention is to provide an adjusting device for an automotive vehicle seat that is simple and fast to manufacture. Manufacturing costs should thereby be as low as possible with the quality of the connection being as high as possible. More specifically, a drive shaft of the adjusting device should be connected to a disc, more specifically to a toothed disc, so as to be exactly concentric therewith. Another object of the present invention is to propose a method of manufacturing such an adjusting device.

In accordance with the invention, this object is solved by an adjusting device in which
the drive shaft extends through the preferably central opening and is non-rotatably connected therewith,
the disc, with its side turned toward the pinion portion, snugly fits against an abutment element,
a groove extending about a central axis of the drive shaft is at least in some sections formed in the outer surface of the drive shaft on the side of the disc that lies opposite the abutment element,
the cutting ring employed for the crimp connection is disposed in the groove in such a manner that the disc is retained with zero clearance between the abutment element and the cutting ring in the longitudinal direction of the drive shaft.

The object is further solved by a method involving the method steps of claim 8.

Accordingly, the connection between the disc and the drive shaft is no longer achieved by a welding process or by a similarly complex method; the components are rather riveted together so to say. The disc fits against an abutment element of the drive shaft that is disposed on sides of the pinion. Accordingly, the cutting ring pushes the toothed disk against this abutment element so that the toothed disc is retained with zero clearance in the longitudinal direction of the drive shaft.

Toothed discs, belt pulleys, pinions or the like may in particular be utilized as the disc, with the term toothed disc being used herein after by way of example. The opening in the disc is preferably disposed in the center but may as well be positioned off center.

The abutment element can be formed by the pinion itself, which means that the toothed disc will fit directly against the pinion or against the teeth of the pinion. The pinion can be mounted to the drive shaft or may be an integral part of said drive shaft, meaning that it is formed out of it.

Alternatively, it is also possible to provide a prominence that is spaced apart from the pinion or from the pinion's teeth respectively and that acts as an abutment element.

The connection is established in that the toothed disc is first pushed over the drive shaft until it reaches and abuts the abutment element or the teeth of the pinion. A groove into which the cutting ring is to be pressed is disposed on the side of the toothed disc that is opposite the pinion. First however, the cutting ring is also pushed over the drive shaft so that it comes to rest against the toothed disc on the side opposite the pinion. Next, a force acting in the longitudinal direction of the drive shaft in the direction of the pinion or of the abutment element respectively is applied to the cutting ring using a tubular tool having approximately the same diameter as the cutting ring. The force is so large that it causes the cutting ring to plastically deform and to be pushed into said groove. Thereby, the groove is on the one side filled with material of the cutting ring, on the other side, material of the cutting ring is directly pushed against the toothed disc so that the latter is firmly retained between the abutment element and the now deformed cutting ring. Accordingly, manufacturing is fast and may be performed using a simple tool. This method further has the advantage that the connection occurs at the same time over the entire circumference so that a uniform connection is always ensured.

In a particularly advantageous implementation variant, the groove extends in the longitudinal direction of the drive shaft comparatively into the region of the opening in the positioned toothed disc. As a result, the cutting ring is also pressed between the drive shaft and the toothed disc, so that zero radial clearance is provided. A further effect of this arrangement of the invention of the groove is that concentricity is ensured thanks to the force acting simultaneously over the entire circumference.

The cutting ring may be made from any suited material, with metals and plastic materials being preferred. It only matters that the material of the cutting ring is suited for permanent plastic deformation without impairing the quality of the material. It is important that the material of the cutting ring be softer than the material of the disc or of the abutment element. Therefore, machining steel or hardened material are out of the question, St 37 steel or also brass being for example suited for this purpose. The material strength of the cutting ring should be lower than the yield strength of the material of the disc. The cutting ring preferably has a Brinell hardness of about 20 to 80, preferably of 40, whereas the disc and the drive shaft have a Brinell hardness of about 100.

The groove extending into the region of the opening in the toothed disc can be further improved in accordance with the invention in that the wall of the groove turned toward the pinion commences at the bottom of said groove where it is first perpendicular thereto and then extends at an incline in the direction of the pinion toward the edge. The advantage thereof is that the material of the cutting ring pressed into the groove is automatically driven in the direction of the toothed disc so that said disc is optimally aligned in concentric relation with the central axis of the drive shaft thanks to the radial force acting over the entire circumference.

In another implementation variant of the invention, the drive shaft is divided into a pinion portion and a connecting portion. The connecting portion is that portion which extends in sections through the toothed disc and the free end of which is connectable for example within the gear to gear members or to a hand-operated gear wheel.

In accordance with the invention, this connecting portion may further be divided into a free portion and a retaining portion, with the retaining portion being that portion onto which the toothed disc is being placed. In the longitudinal direction of the drive shaft, its length approximately corresponds to the width or the depth of the opening in the toothed disc. The retaining portion may have the same diameter as the free portion; it may however also have a diameter greater than the diameter of the free portion. A greater diameter is advantageous because it is then easier for the material of the cutting ring to fill out the groove. The reason therefore is that the cutting ring is first driven by the tubular tool toward the pinion, that is, toward the greater diameter of the retaining portion, and that it deviates in other directions, for example downward or upward, only in a second step.

The adjusting device of the invention, respectively the component parts contained therein and connected together, are suited for use in any adjusting devices of automotive vehicle seats. Accordingly, the adjusting device may be suited for adjusting the lengthwise position, the height and the incline.

### BRIEF DESCRIPTION OF THE DRAWINGS

The invention will be described in closer detail herein after with reference to the FIGS. The component parts illustrated in the FIGS. are only given by way of example and merely serve to explain the invention. In the drawing:

FIG. 1 is an exploded illustration of an adjusting device of the invention,

FIG. 2 shows the adjusting device of FIG. 1 in the assembled condition,

FIG. 3 is a sectional view of the adjusting device of FIG. 2,

FIG. 4 is a schematic detail to an enlarged scale of a groove region before a cutting ring is pressed into it,

FIG. 5 shows the enlarged detail of FIG. 4 with the cutting ring being pressed in.

### DETAILED DESCRIPTION

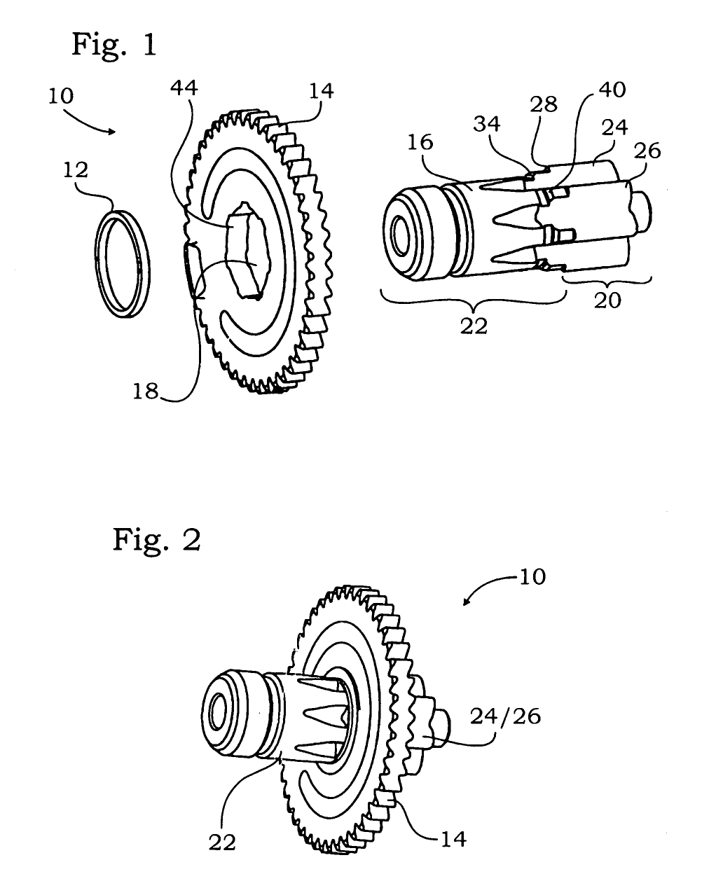

As is particularly evident from the FIGS. 1 through 3, an adjusting device 10 of the invention for an automotive vehicle seat that has not been illustrated herein comprises a cutting ring 12, a disc, preferably a toothed disc 14 and a drive shaft 16. In the present exemplary embodiment, the disc is implemented as a toothed disc 14 but it may also be formed from any other kind of force-transmitting disc.

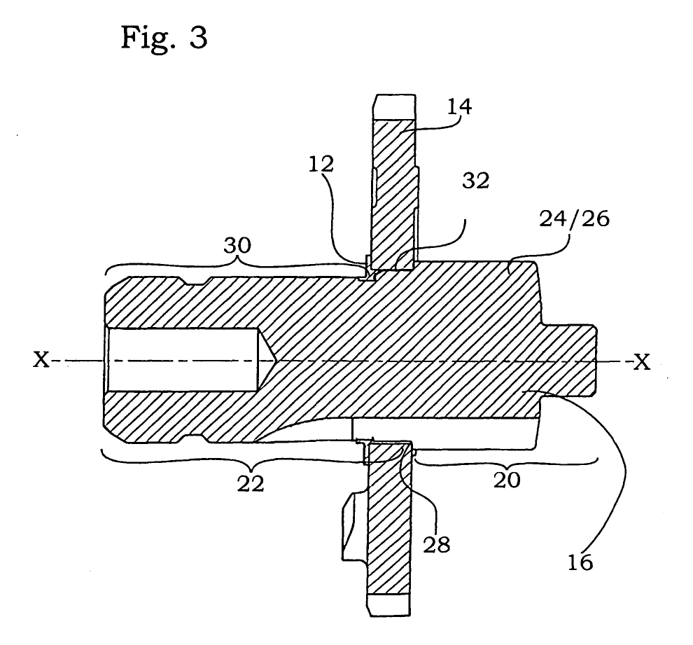

As best shown in FIG. 2, the drive shaft 16 extends, in the assembled condition of the adjusting device 10, through a central opening 18 in the toothed disc 14. The toothed disc 14 and the drive shaft 16 are disposed in concentric relation with a common central axis X-X that passes through the center of the opening 18 and extends in the longitudinal direction of the drive shaft 16 (see FIG. 3 in particular). The toothed disc 14 is non rotatable, in the instant case it is retained on the drive shaft 16 in the direction of rotation about the central axis X-X because it interlockingly mates therewith.

The drive shaft 16 is substantially divided into a pinion portion 20 and a connecting portion 22. The pinion portion 20 comprises a pinion 24 that may be placed onto the pinion portion 20 but may also be configured integral with the drive shaft 16. The pinion 24 comprises teeth 26.

In the assembled condition, the toothed disc 14 fits against at least one abutment element 28. Said abutment element may be formed by a prominence, preferably by a prominence extending over the circumference about the drive shaft 16, although the implementation of the invention shown in the FIGS. is also possible in which the teeth 26 of the pinion 24 serve as abutment elements 28. The cutting ring 12 secures the toothed disc 14 against the teeth 26.

FIG. 3 clearly shows that the connecting portion 22 can further be divided into a free portion 30 and a retaining portion 32. The free portion 30 extends into a gear (not shown) or is connectable to a hand-operated adjusting member. Generally, the connecting portion 22 serves for connection to a motor drive, or to a gear or to a hand-adjustable actuation means. As also clearly shown in FIG. 3, the retaining portion 32 comprises, in the longitudinal direction of the central axis X-X, approximately the same width as the toothed disc 14.

The FIGS. 3 through 5 clearly show a particularly advantageous implementation variant of a groove 34 which is formed into the outer face of the connecting portion 22 and into which the cutting ring 12 is pressed using a tubular tool (not shown) for securing the toothed disc 14 against the abutment element or elements 28. In the described exemplary embodiment of the invention, said toothed disc extends over its entire circumference about the central axis X-X and in cross section along the central axis X-X, preferably into the region of the opening 18 in the toothed disc 14. In the present exemplary embodiment, the retaining portion 32 terminates in the groove 34 in the region of the opening 18. In the exemplary embodiment shown, the retaining portion 32 has a greater diameter than the free portion 30.

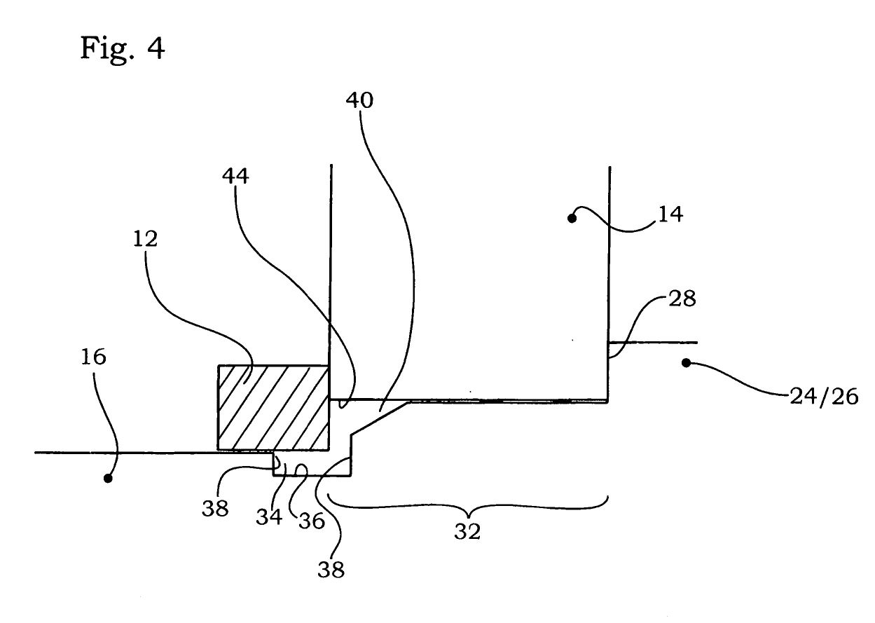

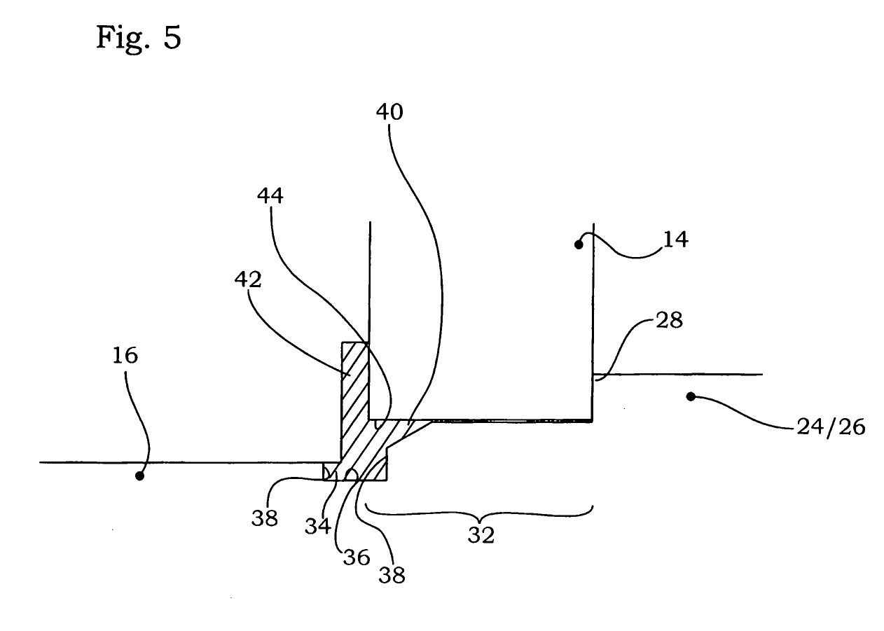

The groove 34 comprises a groove bottom 36 that is bounded by groove walls 38. In the present exemplary embodiment, the groove walls 38 are perpendicular to the groove bottom 36. The groove wall 38 disposed on sides of the abutment element 28 or of the pinion 24 comprises an inclined surface 40 that commences at the groove 34 and ascends toward the abutment element 28 prior to terminating at the outer circumference of the drive shaft 16. As best shown in the FIGS. 4 and 5, this peculiar shape of the groove allows the cutting ring 12, by plastically deforming, to on the one side secure the toothed disc 14 in the longitudinal direction by a protrusion 42 fitting against the toothed disc 14 and to, on the other side, press it in the radial direction against an inner wall 44 of the opening 18 as a result of the deformation promoted by the inclined surface 40, thus effecting accurate concentricity, which additionally provides for zero clearance in the radial direction. In the embodiment shown, the tool (not shown) presses the cutting ring 12 against the grove wall 38 that forms the transition between the free portion 30 and the retaining portion 32.

The adjusting device described 10 is particularly suited for motor driven adjusting devices for automotive vehicle seats.

1. An adjusting device for an automotive vehicle seat, having a drive shaft that comprises a pinion portion and a connecting portion, a disc with a preferably central opening and a cutting ring, wherein
the drive shaft extends through the central opening and is non-rotatably connected therewith,
the disc, with its side turned toward the pinion portion, fits against an abutment element,
a groove extending about a central axis (X-X) of the drive shaft is at least in some sections formed in the outer surface of the drive shaft on the side of the disc that lies opposite the abutment element,
the cutting ring employed for the crimp connection is disposed in the groove in such a manner that the disc is retained with zero clearance between the abutment element and the cutting ring in the longitudinal direction of the drive shaft.

2. The adjusting device as set forth in claim 1, wherein, in cross section, the groove extends along the central axis (X-X) of the drive shaft into the region of the opening of the disc so that the cutting ring pressed into the groove fits against an inner wall of the opening and exerts a force in a radial direction.

3. The adjusting device as set forth in claim 1, wherein the groove comprises a groove bottom and groove walls, the groove wall disposed on sides of the abutment element comprising an inclined surface that commences at the groove and ascends toward the abutment element prior to terminating at the outer circumference of the drive shaft.

4. The adjusting device as set forth in claim 1, wherein the connecting portion is divided into a free portion and a retaining portion, with the disc being disposed in the region of the retaining portion, said retaining portion having a greater diameter than the free portion.

5. The adjusting device as set forth in claim 1, wherein the abutment element is formed by teeth of a pinion disposed on the pinion portion.

6. The adjusting device as set forth in claim 1, wherein the drive shaft is motor driven.

7. The adjusting device as set forth in claim 1, wherein the disc is configured to be a toothed disc.

8. A method of manufacturing an adjusting device in accordance with claim 1, comprising the steps of:
introducing the drive shaft into a preferably central opening in the disc until an abutment element of the drive shaft snugly fits against the disc,
positioning a cutting ring in the region of a groove formed in the outer surface of the drive shaft and extending about a central axis (X-X) of the drive shaft, said groove being at least in sections disposed on the side of the disc that lies opposite the abutment element,
pressing the cutting ring into the groove with said cutting ring undergoing thereby plastic deformation so that a protrusion of the plastically deformed cutting ring presses against the disc and that said disc is retained with zero clearance between the abutment element and the cutting ring.
